(19) United States
(12) Patent Application Publication
(10) Pub. No.: US 2005/0015798 A1
(43) Pub. Date: Jan. 20, 2005

(54) Index-information generating apparatus content presenting apparatus and content presenting system

(76) Inventors: Masato Yamamichi, Kadoma-shi (JP); Motoji Ohmori, Hirakata-shi (JP); Makoto Tatebayashi, Takarazuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/488,559

(22) PCT Filed: Aug. 29, 2002
(86) PCT No.: PCT/JP02/08719

(30) Foreign Application Priority Data
Sep. 5, 2001 (JP) 2001-268461

(51) Int. Cl. H04N 7/025; H04N 7/16; H04N 7/10

(52) U.S. Cl. 725/32; 725/135; 725/136; 715/512; 715/501.1; 725/8; 725/1

(57) ABSTRACT

To provide a broadcasting system in which a content user can select CMs that he or she wants. A sub-content index-information presenting unit presents sub-content index information. A user selects in advance sub-contents that he or she wants to view, by referring to the sub-content index information, and views only the selected sub-contents.

### TECHNICAL FIELD

The present invention relates to presentation of content by sound, display, etc., and particularly to a technique for presenting commercial messages within a presentation time period of broadcast program content.

### BACKGROUND ART

In the current system of commercial TV broadcast, broadcast programs are mainly produced using fees paid by sponsors and the broadcast programs are broadcasted with commercial messages (hereafter, “CMs”) of the sponsors being inserted therein, so that viewers can enjoy the broadcast programs at no charge. However, with the widespread of recording devices for broadcast programs, such as VCRs and DVD recorders, viewers can record broadcast programs with inserted CMs using such recording devices. Theses viewers may skip the CMs to view the broadcast programs by utilizing, for example, the fast-forward function of VCRs. If an increasing number of viewers come to skip CMs when viewing broadcast programs, the sponsors of the CMs may consider withdrawing from such advertising method that utilizes TV broadcast. In other words, because the effectiveness of the CMs is reduced, these sponsors may stop sponsoring the broadcast programs. As a result of this, the current system of commercial TV broadcast may be collapsed.

Here, software such as the above-mentioned broadcast programs, and movies, documents, musical compositions, computer programs, and databases, or combinations of these are referred to as “content”. With the start of BS digital broadcasts and the widespread of the Internet, content distribution has been actively performed in recent years. In view of this, too, a solution to the above-described problem is desperately being called for.

To respond to this, Japanese Laid-open Patent Application No. H7-203420 proposes a system in which CMs are broadcasted in accordance with the CM acceptability to each viewer and a program viewing fee for each viewer is discounted accordingly. In this system, a pay broadcast program is broadcasted with a different frequency of CMs for each viewer according to his or her CM acceptability, and a viewing fee of the pay broadcast program to be charged to each viewer is discounted according to the frequency of CMs being broadcasted.

Japanese Laid-open Patent Application No. H7-203420 also discloses a method for enabling such a bi-directional broadcasting system in which a transmission side changes the frequency of CMs to be added to a pay broadcast program selected by a reception side according to the CM acceptability to the reception side, and broadcasts the pay broadcast program with the CMs. According to this method, only the frequency of CMs to be broadcasted can be changed according to the CM acceptability to each reception side. In this case, however, the viewer is not allowed to freely select CMs that he or she wants.

### DISCLOSURE OF THE INVENTION

To solve the above problems of conventional techniques, the first object of the present invention is to provide an index-information generating apparatus, a content presenting apparatus, and a content presenting system that allow a content user to select CMs that the user wants.

Further, the second object of the present invention is to provide a content presenting system that allows the content user to select a utility fee of pay content as a result of the above CM selection.

The first object of the present invention can be achieved by the content presenting apparatus of the present invention, including: a content obtaining unit for obtaining a main-content and a sub-content; a time-information obtaining unit for obtaining presentation time information for a sub-content, the presentation time information indicating a start point and an end point of presenting the sub-content to a user; an index-information presenting unit for presenting, to the user, sub-content index information describing a plurality of sub-contents; a user-selection receiving unit for receiving, from the user, a selection of a sub-content out of the plurality of sub-contents described in the sub-content index information; a specification-information generating unit for generating specification information that specifies the sub-content selected by the user; a main-content presenting unit for presenting the main-content to the user; and a sub-content presenting unit for presenting, to the user, the sub-content specified by the specification information, from a start point to an end point indicated by presentation time information for the specified sub-content, within a time period from when presentation of the main-content is started to when presentation of the main-content is ended.

According to this construction, the user can select in advance sub-contents that he or she wants, by referring to the sub-content index presented via sound or a screen display by the index-information presenting unit. Therefore, the user can view only the selected sub-contents.

Here, the content presenting apparatus of the present invention may further include an index-information obtaining unit for obtaining, from an index-information generating apparatus, the sub-content index information that is presented by the index-information presenting unit.

Here, the content presenting apparatus of the present invention may further include an index-information generating unit for generating the sub-content index information that is presented by the index-information presenting unit, the index-information generating unit including: an accumulation unit that accumulates sub-contents, in association with IDs identifying the sub-contents and description information describing the sub-contents; and an extraction unit that extracts, from the accumulation unit, sub-contents to be described in the sub-content index information, by referring to the description information describing the sub-contents.

Here, in the content presenting apparatus of the present invention, the sub-content index information may include an ID unique to each sub-content, in association with at least one of a type, a broadcast time, a viewing fee, a production date, a viewing record, a representative image, and a performer, and the index-information presenting unit may display the sub-content index information on a screen.

Here, the content presenting apparatus of the present invention may further include a specification-information updating unit for updating the specification information, based on a selection by the user.

According to this construction, even after the user has selected sub-contents that he or she wants, the user is allowed to change the selection.

The first object of the present invention can also be achieved by the index-information generating apparatus of the present invention, including: a content outputting unit for outputting a main-content and a sub-content to a recording medium or a content presenting apparatus; an index-information generating unit for generating sub-content index information describing a plurality of sub-contents; an index-information outputting unit for outputting the sub-content index information to the recording medium or the content presenting apparatus; and a time-information outputting unit for outputting presentation time information for each sub-content to the recording medium or the content presenting apparatus, the presentation time information indicating a start point and an end point of presenting the sub-content to the user.

According to this construction, using the content presenting apparatus, the user can select in advance sub-contents that he or she wants, by referring to the sub-content index and so can view only the selected sub-contents.

Here, in the index-information generating apparatus of the present invention, the index-information generating unit may include: an accumulation unit that accumulates sub-contents, in association with IDs identifying the sub-contents and description information describing the sub-contents; and an extraction unit that extracts, from the accumulation unit, sub-contents to be described in the sub-content index information, by referring to the description information describing the sub-contents.

The first object of the present invention can also be achieved by the content presenting system of the present invention including a transmission apparatus and a reception apparatus, the transmission apparatus including: a content transmitting unit for transmitting a main-content and a sub-content; and a time-information transmitting unit for transmitting presentation time information for a sub-content, the presentation time information indicating a start point and an end point of presenting the sub-content to a user, and the reception apparatus including: a content receiving unit for receiving the main-content and the sub-content; a time-information receiving unit for receiving the presentation time information; an index-information presenting unit for presenting, to the user, sub-content index information describing a plurality of sub-contents; a user-selection receiving unit for receiving, from the user, a selection of a sub-content out of the plurality of sub-contents described in the sub-content index information; a specification-information generating unit for generating specification information that specifies the sub-content selected by the user; a main-content presenting unit for presenting the main-content to the user; and a sub-content presenting unit for presenting, to the user, the sub-content specified by the specification information, from a start point to an end point indicated by presentation time information for the specified sub-content, within a time period from when presentation of the main-content is started to when presentation of the main-content is ended.

According to this construction, using the reception apparatus, the user can select in advance sub-contents that he or she wants, by referring to the sub-content index and so can view only the selected sub-contents.

To achieve the second object of the present invention, in the content presenting system of the present invention, the reception apparatus may further include, a specification-information outputting unit for outputting the specification information to a recording medium or the transmission apparatus, after the sub-content presenting unit has completed presentation of each sub-content specified by the specification information to the user, and the transmission apparatus may further include: a specification-information obtaining unit for obtaining the specification information; and a first payment-amount determining unit for determining a payment amount to be charged to the reception apparatus, based on the specification information.

According to this construction, sub-contents that the user wants are selected and a payment amount to be charged to the user is determined according to the selected sub-contents. This means that the user is allowed to select even a utilization fee of pay content.

Here, in the content presenting system of the present invention, the transmission apparatus may further include, a first payment-amount outputting unit for outputting the payment amount determined by the first payment-amount determining unit, to a recording medium or the reception apparatus, and the reception apparatus may further include: a payment-amount obtaining unit for obtaining the payment amount; and a payment-amount presenting unit for presenting the payment amount to the user.

Here, in the content presenting system of the present invention, the transmission apparatus may further include: a second payment-amount determining unit for determining a payment amount to be charged to a sub-content production apparatus, based on the obtained specification information; and a second payment-amount outputting unit for outputting the payment amount determined by the second payment-amount determining unit, to a recording medium or the sub-content production apparatus.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 shows the construction of a broadcasting system 1 in an embodiment of the present invention;

FIG. 2 shows the construction of a broadcasting apparatus 11 in the embodiment of the present invention;

FIG. 3 shows the construction of a broadcast receiving apparatus 12 in the embodiment of the present invention;

FIG. 4 shows the construction of a CM consigning apparatus 13;

FIG. 5 shows an example of CM distribution information in the embodiment of the present invention;

FIG. 6 shows an example of CM index information in the embodiment of the present invention;

FIG. 7 shows an example of CM viewing information in the embodiment of the present invention;

FIG. 8 shows the first part of a processing sequence of the broadcasting system 1 in the embodiment of the present invention;

FIG. 9 shows the middle part of the processing sequence of the broadcasting system 1 in the embodiment of the present invention; and

FIG. 10 shows the last part of the processing sequence of the broadcasting system 1 in the embodiment of the present invention.

### BEST MODE FOR CARRYING OUT THE INVENTION

The following describes an embodiment of the present invention, with reference to the drawings.

The following describes the embodiment of the present invention in a case where a broadcaster successively distributes pay broadcast programs each at its scheduled broadcast time, and viewers successively view the distributed broadcast programs each at its scheduled broadcast time.

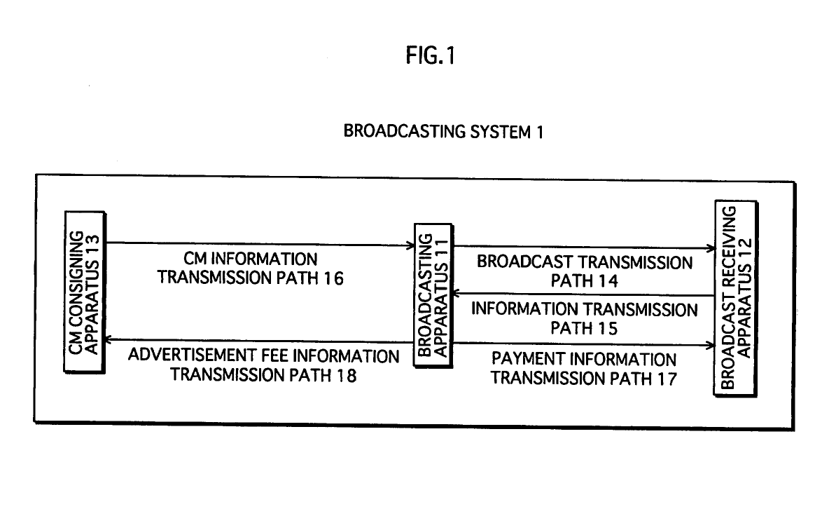

First, a general outline of the present embodiment is given, with reference to FIG. 1. In the figure, a broadcasting apparatus 11 is used by a broadcaster who distributes pay broadcast programs, a broadcast receiving apparatus 12 is used by one of viewers who view the pay broadcast programs, and a CM consigning apparatus 13 is used by one of advertisers who consign broadcast of CMs that are to be inserted into the pay broadcast programs.

In the present embodiment, the broadcaster receives CM broadcasts using a CM information transmission path 16, and distributes an index of the CM broadcasts to the viewer using a broadcast transmission path 14. The viewer views the index of the CM broadcasts that has been transmitted via the broadcast transmission path 14 by the broadcaster, and selects CM broadcasts that he or she wants. The broadcaster distributes pay broadcast programs, CM broadcasts, and a CM distribution signal using the broadcast transmission path 14. The CM distribution signal indicates where each CM broadcast is to be inserted in pay broadcast programs. Based on the CM distribution signal, the viewer views a pay broadcast program in which only the CM broadcasts that he or she wants are inserted, out of the pay broadcast programs and the CM broadcasts that have been transmitted via the broadcast transmission path 14 by the broadcaster. The viewer transmits, to the broadcaster, a selection result showing the CM broadcasts that the viewer has selected, using the information transmission path 15.

By referring to the transmitted selection result, the broadcaster calculates a fee to be charged to the viewer, by subtracting a discount amount according to the degree of CM broadcasts viewed by the viewer, from a predetermined viewing fee of the broadcast program. The broadcaster then transmits information about this discounted viewing fee to the viewer, using a payment information transmission path 17. Here, a viewing fee of the pay broadcast program to be paid to the broadcaster decreases as the degree of CM broadcasts viewed by the viewer increases. To make up for the decreased amount, the broadcaster increases an advertisement fee of the CM broadcasts to be paid by the advertiser, according to the degree of CM broadcasts viewed by the viewer. The broadcaster transmits information about the increased advertisement fee to the advertiser, using an advertisement fee information transmission path 18.

As described above, the viewer can select CM broadcasts that he or she wants, and as a result of this selection, the viewer can select a utilization fee of a pay broadcast program. The description given so far is a general outline of the present embodiment. Next, the following describes the present embodiment in more detail.

(Construction of the Broadcasting System 1)

FIG. 1 shows the construction of the broadcasting system 1 in the embodiment of the present invention. In the broadcasting system 1, a broadcaster distributes a pay broadcast program in which CM broadcasts of an advertiser are inserted, and a viewer of the pay broadcast program is allowed to select a viewing fee of the pay broadcast program. The broadcasting system 1 includes the broadcasting apparatus 11, the broadcast receiving apparatus 12, the CM consigning apparatus 13, the broadcast transmission path 14, the information transmission path 15, the CM information transmission path 16, the payment information transmission path 17, and the advertisement fee information transmission path 18. The broadcasting apparatus 11 distributes broadcast program information, CM information, CM distribution information, and CM index information, to the broadcast receiving apparatus 12. The broadcast receiving apparatus 12 receives broadcast program information, CM information, CM distribution information, and CM index information. The CM consigning apparatus 13 transmits CM information to the broadcasting apparatus 11. The broadcast transmission path 14 can transmit broadcast program information, CM information, CM distribution information, and CM index information from the broadcasting apparatus 11 to the broadcast receiving apparatus 12. The information transmission path 15 can transmit CM viewing information from the broadcast receiving apparatus 12 to the broadcasting apparatus 11. The CM information transmission path 16 can transmit CM information from the CM consigning apparatus 13 to the broadcasting apparatus 11. The payment information transmission path 17 can transmit payment information from the broadcasting apparatus 11 to the broadcast receiving apparatus 12. The advertisement fee information transmission path 18 can transmit advertisement fee information from the broadcasting apparatus 11 to the CM consigning apparatus 13.

Here, the “broadcast program information” is transmission information for pay broadcast programs. In the present embodiment, the broadcast program information is digital information obtained by encoding video and audio information of pay broadcast programs according to the MPEG-2 (moving picture experts group phase 2) format.

The “CM information” is transmission information for CM broadcasts. In the present embodiment, the CM information is digital information obtained by encoding video and audio information of CM broadcasts according to the MPEG-2 format.

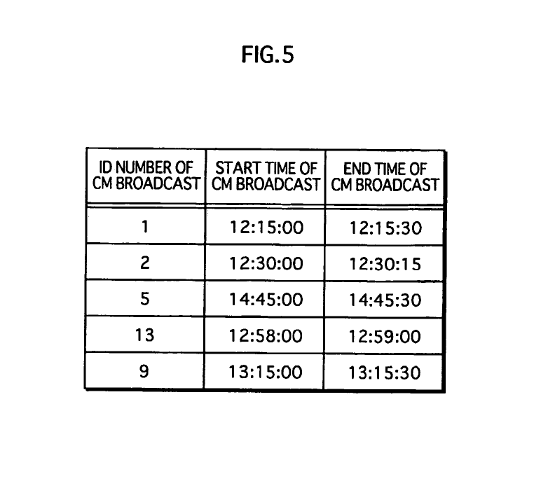

The “CM distribution information” indicates where each CM broadcast is to be inserted in a broadcast program. In the present embodiment, the CM distribution information specifically is a table listing ID numbers of CM broadcasts to be inserted into a broadcast program, each ID number being associated with a time period (a start time and an end time) during which the CM broadcast is being inserted, as shown in FIG. 5.

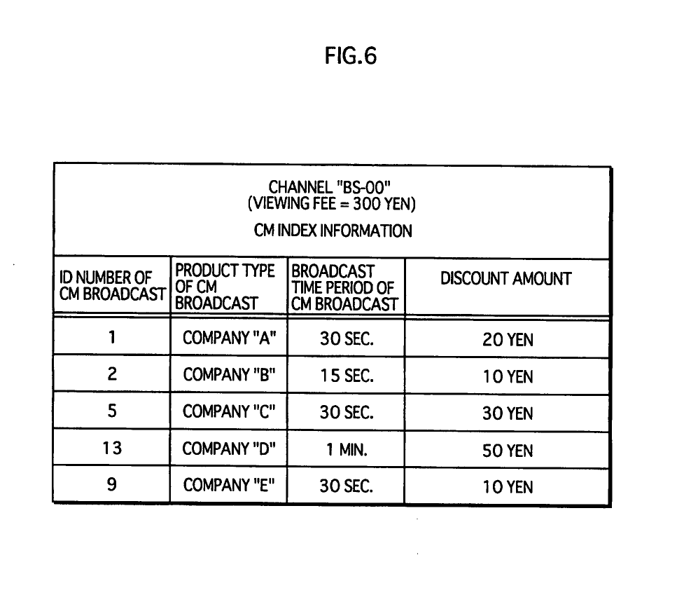

The “CM index information” is transmission information that indicates characteristics of CM broadcasts. In the present embodiment, the CM index information specifically is a table listing ID numbers of CM broadcasts to be inserted into a broadcast program, each ID number being associated with a product type of the CM broadcast (e.g., an advertising company name, or an advertising commodity such as food, music, and car), a broadcast time period of the CM broadcast, and a discount amount by which a viewing fee of the broadcast program is discounted when the viewer views the CM broadcast, as shown in FIG. 6.

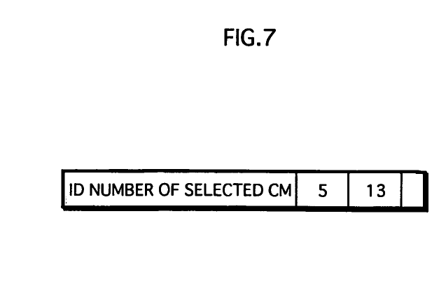

The “CM viewing information” specifies CM broadcasts that the viewer wants. In the present embodiment, the CM viewing information specifically is a table listing ID numbers of CM broadcasts selected by the viewer, as shown in FIG. 7.

The “payment information” is transmission information about a viewing fee of a broadcast program to be charged to the viewer.

The “advertisement fee information” is transmission information about an advertisement fee of CM broadcasts to be charged to the advertiser.

The following describes each of these components in more detail.

First, the broadcasting apparatus 11, the broadcast receiving apparatus 12, and the CM consigning apparatus 13 that are the components of the broadcasting system 1 are described. The following describes the construction of the broadcasting apparatus 11 and then the processing of the broadcasting apparatus 11.

(Construction of the Broadcasting Apparatus 11)

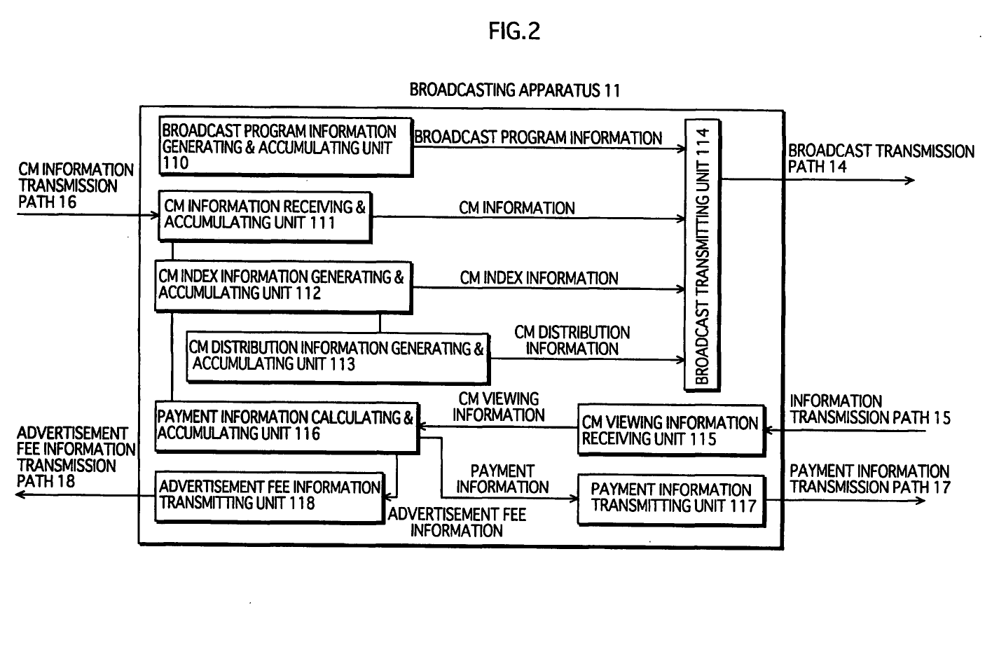

FIG. 2 shows the construction of the broadcasting apparatus 11. The broadcasting apparatus 11 is used by the broadcaster to distribute a pay broadcast program to the viewer. The broadcasting apparatus 11 includes a broadcast program information generating & accumulating unit 110, a CM information receiving & accumulating unit 111, a CM index information generating & accumulating unit 112, a CM distribution information generating & accumulating unit 113, a broadcast transmitting unit 114, a CM viewing information receiving unit 115, a payment information calculating & accumulating unit 116, a payment information transmitting unit 117, and an advertisement fee information transmitting unit 118. The broadcast program information generating & accumulating unit 110 generates and accumulates broadcast program information. The CM information receiving & accumulating unit 111 receives CM information via the CM information transmission path 16, and accumulates the received CM information. The CM index information generating & accumulating unit 112 can access the CM information receiving & accumulating unit 111, and generates and accumulates CM index information. The CM distribution information generating & accumulating unit 113 can access the CM index information generating & accumulating unit 112, and generates and accumulates CM distribution information. The broadcast transmitting unit 114 outputs broadcast program information, CM information, CM index information, and CM distribution information to the broadcast transmission path 14. The CM viewing information receiving unit 115 receives CM viewing information via the information transmission path 15. The payment information calculating & accumulating unit 116 can access the CM index information generating & accumulating unit 112, and calculates payment information and advertisement fee information using CM viewing information, and accumulates the payment information and the advertisement fee information. The payment information transmitting unit 117 outputs payment information to the payment information transmission path 17. The advertisement fee information transmitting unit 118 outputs advertisement fee information to the payment fee information transmission path 18.

(Processing of the Broadcasting Apparatus 11)

The broadcast program information generating & accumulating unit 110 generates broadcast program information and accumulates the generated broadcast program information.

The CM information receiving & accumulating unit 111 receives CM information via the CM information transmission path 16, adds a unique ID number to the CM information, and accumulates the CM information with the ID number.

The CM index information generating & accumulating unit 112 that can access the CM information receiving & accumulating unit 111 reads CM information accumulated in the CM information receiving & accumulating unit 111, selects CM information to be inserted into broadcast program information. Then, the CM index information generating & accumulating unit 112 extracts the selected CM information, based on information associated with the selected CM information, such as an ID number, a product type (e.g., an advertising company name, or an advertising commodity such as food, music, and car), a broadcast time period, a discount amount by which a viewing fee of the broadcast program information is to be discounted when the CM information is viewed, and the like. The CM index information generating & accumulating unit 112 then generates CM index information that is a table listing ID numbers of CM information and CM characteristics in association with each other, and accumulates the generated CM index information. It should be noted here that the CM information receiving & accumulating unit 111 not only accumulates CM information, but also stores ID numbers and other characteristics of the accumulated CM information. The CM index information generating & accumulating unit 112 refers to the ID numbers and the characteristics stored in the CM information receiving & accumulating unit 111, and extracts CM information to be included in the CM index information. The CM index information generating & accumulating unit 112 generates the CM index information with such a data structure in which an ID number of CM information is associated with a characteristic of the CM information.

The CM distribution information generating & accumulating unit 113 that can access the CM index information generating & accumulating unit 112 reads CM index information accumulated in the CM index information generating & accumulating unit 112, and generates and accumulates CM distribution information listing ID numbers of CM information selected by the CM index information generating & accumulating unit 112, each ID number being associated with time information indicating a time period (a start time and an end time) during which CM information identified by the ID number is to be inserted into the broadcast program information. The CM distribution information is generated by referring to information about broadcast time periods of broadcast programs.

At a time when the broadcast transmission path 14 is available, like in the nighttime, CM information is read from the CM information receiving & accumulating unit 111, CM index information is read from the CM index information generating & accumulating unit 112, and CM distribution information is read from the CM distribution information generating & accumulating unit 113. The read CM information, CM index information, and CM distribution information are inputted into the broadcast transmitting unit 114. The broadcast transmitting unit 114 outputs the input CM information, CM index information, and CM distribution information to the broadcast transmission path 14.

At the scheduled broadcast time of broadcast program information, the broadcast program information is read from the broadcast program information generating & accumulating unit 110, and is inputted into the broadcast transmitting unit 114. The broadcast transmitting unit 114 outputs the input broadcast program information to the broadcast transmission path 14.

The CM viewing information receiving unit 115 receives CM viewing information listing ID numbers of CM information selected by the viewer, and inputs the received CM viewing information into the payment information calculating & accumulating unit 116.

The payment information calculating & accumulating unit 116 that can access the CM index information generating & accumulating unit 112 reads CM index information accumulated in the CM index information generating & accumulating unit 112. Based on the input CM viewing information, the payment information calculating & accumulating unit 116 calculates a fee to charged to the viewer, by subtracting a discount amount according to the degree of CM broadcasts that have been viewed by the viewer, from a predetermined viewing fee of the broadcast program information. The payment information calculating & accumulating unit 116 accumulates the calculated fee as payment information. Also, the payment information calculating & accumulating unit 116 calculates a fee to be charged to the advertiser by adding the discount amount to the advertisement fee. The payment information calculating & accumulating unit 16 accumulates the calculated fee as advertisement fee information.

Payment information is read from the payment information calculating & accumulating unit 116 at predetermined intervals, e.g., every month, and is inputted into the payment information transmitting unit 117. The payment information transmitting unit 117 outputs the input payment information to the payment information transmission path 17.

Advertisement fee information is read from the payment information calculating & accumulating unit 116 at predetermined intervals, e.g., every month, and is inputted into the advertisement fee information transmitting unit 118. The advertisement fee information transmitting unit 118 outputs the input advertisement fee information to the advertisement fee information transmission path 18.

Next, the following describes the construction of the broadcast receiving apparatus 12 and then the processing of the broadcast receiving apparatus 12.

(Construction of the Broadcast Receiving Apparatus 12)

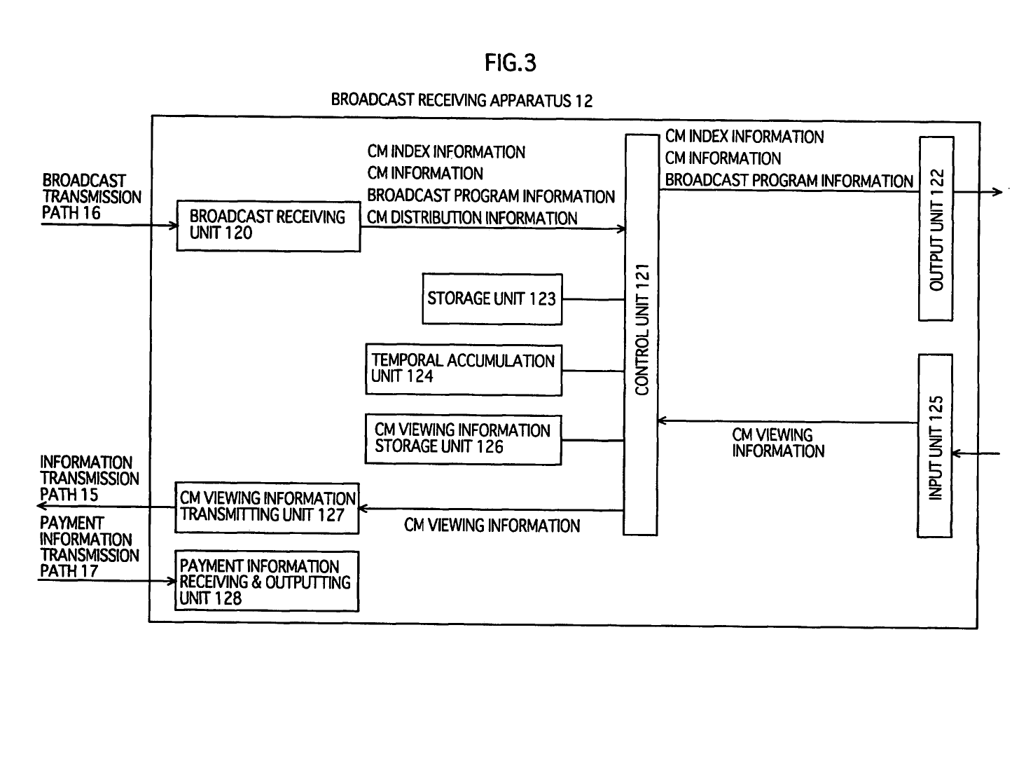

FIG. 3 shows the construction of the broadcast receiving apparatus 12. The broadcast receiving apparatus 12 is used by the viewer to receive and view a pay broadcast program. The broadcast receiving apparatus 12 includes a broadcast receiving unit 120, a control unit 121, an output unit 122, a storage unit 123, a temporal accumulation unit 124, an input unit 125, a CM viewing information storage unit 126, a CM viewing information transmitting unit 127, and a payment information receiving & outputting unit 128. The broadcast receiving unit 120 receives CM information, CM index information, CM distribution information, and broadcast program information. The control unit 121 controls output of each of CM information, CM index information, and broadcast program information. The output unit 122 outputs CM information, CM index information, and broadcast program information to the outside. The storage unit 123 is accessible by the control unit 121, and stores CM information, CM index information, and CM distribution information. The temporal accumulation unit 124 is accessible by the control unit 121, and temporarily accumulates broadcast program information. The input unit 125 receives input of CM viewing information from the outside, and outputs the received CM viewing information to the control unit 121. The CM viewing information storage unit 126 is accessible by the control unit 121, and stores CM viewing information. The CM viewing information transmitting unit 127 outputs CM viewing information to the information transmission path 15. The payment information receiving & outputting unit 128 receives payment information via the payment information transmission path 17 and outputs the received payment information to the outside.

(Processing of the Broadcast Receiving Apparatus 12)

First, the broadcast receiving unit 120 receives CM information, CM index information, and CM distribution information, and inputs the received CM information, CM index information, and CM distribution information into the control unit 121.

The control unit 121 stores the input CM information, CM index information, and CM distribution information into the storage unit 123.

The broadcast receiving unit 120 successively receives broadcast program information at the scheduled broadcast time of the broadcast program information, and successively inputs the received broadcast program information into the control unit 121. Then, the control unit 121 successively accumulates the input broadcast program information into the temporal accumulation unit 124. Then, the control unit 121 outputs the CM index information stored in the storage unit 123 to the output unit 122.

The output unit 122 outputs the input CM index information to the outside. Here, typical examples of the output unit 122 are a display and a speaker. Such CM index information as shown in FIG. 6 is outputted to the outside.

The input unit 125 receives CM viewing information based on the viewer's operation given outside the apparatus, and outputs the CM viewing information to the control unit 121. The control unit 121 stores the CM viewing information into the CM viewing information storage unit 126.

The control unit 121 outputs CM information, or broadcast program information accumulated in the temporal accumulation unit 124, to the outside of the apparatus, by outputting the CM information or the broadcast program information to the output unit 122 by the following procedure.

(i) The control unit 121 checks CM distribution information stored in the storage unit 123 and CM viewing information stored in the CM viewing information storage unit 126.

(ii) When an ID number included in the CM distribution information matches an ID number included in the CM viewing information, the control unit 121 outputs, to the output unit 122, CM information identified by the ID number stored in the storage unit 123 during a time period shown by time information in the CM distribution information. At the same time, the control unit 121 accumulates input broadcast program information into the temporal accumulation unit 124.

(iii) Except the case (ii), the control unit 121 outputs broadcast program information accumulated in the temporal accumulation unit 124 to the output unit 122, and at the same time, accumulates input broadcast program information into the temporal accumulation unit 124.

The control unit 121 inputs CM viewing information stored in the CM viewing information storage unit 126 into the CM viewing information transmitting unit 127 after outputting all broadcast program information to the output unit 122. The CM viewing information transmitting unit 127 outputs the input CM viewing information to the information transmission path 15.

The payment information receiving & outputting unit 128 receives payment information via the payment information transmission path 17, and outputs the received payment information to the outside.

Next, the following describes the construction of the CM consigning apparatus 13 and then the processing of the CM consigning apparatus 13.

(Construction of the CM Consigning Apparatus 13)

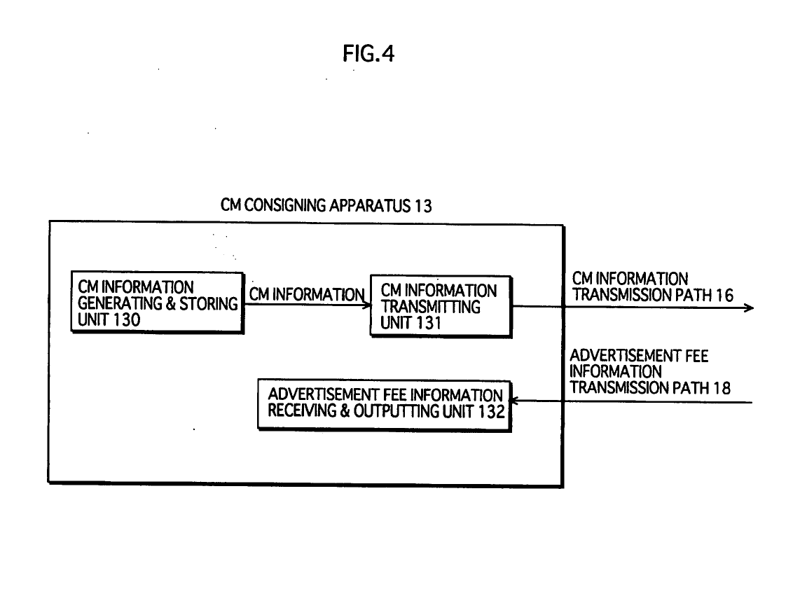

FIG. 4 shows the construction of the CM consigning apparatus 13. The CM consigning apparatus 13 is used by the advertiser to consign broadcast of CM information to the broadcaster. The CM consigning apparatus 13 includes a CM information generating & storing unit 130, a CM information transmitting unit 131, and an advertisement fee information receiving & outputting unit 132. The CM information generating & storing unit 130 generates and stores CM information. The CM information transmitting unit 131 outputs CM information to the CM information transmission path 16. The advertisement fee information receiving & outputting unit 132 receives advertisement fee information via the advertisement fee information transmission path 18 and outputs the advertisement fee information to the outside.

(Processing of the CM Consigning Apparatus 13)

First, the CM information generating & storing unit 130 generates CM information and stores the generated CM information. The CM information generating & storing unit 130 then inputs the CM information stored therein, into the CM information transmitting unit 131.

The CM information transmitting unit 131 outputs the input CM information to the CM information transmission path 16.

The advertisement fee information receiving & outputting unit 132 receives advertisement fee information via the advertisement fee information transmission path 16, and outputs the received advertisement fee information to the outside.

The description given so far is on the broadcasting apparatus 11, the broadcast receiving apparatus 12, and the CM consigning apparatus 13 that are the components of the broadcasting system 1. Next, the following describes the remaining components of the broadcasting system 1, i.e., the broadcast transmission path 14, the information transmission path 15, the CM information transmission path 16, the payment information transmission path 17, and the advertisement fee information transmission path 18.

(Construction of the Broadcast Transmission Path 14)

The broadcast transmission path 14 is a transmission path capable of transmitting CM information, CM index information, CM distribution information, and broadcast program information from the broadcasting apparatus 11 to the broadcast receiving apparatus 12. In the present embodiment, a radio transmission path with the same frequency bandwidth as that used for BS digital broadcast is used as this broadcast transmission path 14.

(Construction of the Information Transmission Path 15)

The information transmission path 15 is a transmission path capable of transmitting CM viewing information from the broadcast receiving apparatus 12 to the broadcasting apparatus 11. In the present embodiment, a telephone line is used as this information transmission path 15.

(Construction of the CM Information Transmission Path 16)

The CM information transmission path 16 is a transmission path capable of transmitting CM information from the CM consigning apparatus 13 to the broadcasting apparatus 11. In the present embodiment, a special line dedicated to transmission of CM information from the CM consigning apparatus 13 to the broadcasting apparatus 11 is used as this CM information transmission path 16.

(Construction of the Payment Information Transmission Path 17)

The payment information transmission path 17 is a transmission path capable of transmitting payment information from the broadcasting apparatus 11 to the broadcast receiving apparatus 12. In the present embodiment, a telephone line is used as this payment information transmission path 17.

(Construction of the Advertisement Fee Information Transmission Path 18)

The advertisement fee information transmission path 18 is a transmission path capable of transmitting advertisement fee information from the broadcasting apparatus 11 to the CM consigning apparatus 13. In the present embodiment, a telephone line is used as this advertisement fee information transmission path 18.

The description given so far is on the components of the broadcasting system 1.

Finally, the following describes the overall processing of the broadcasting system 1 having the above-described construction.

(Overall Processing of the Broadcasting System 1)

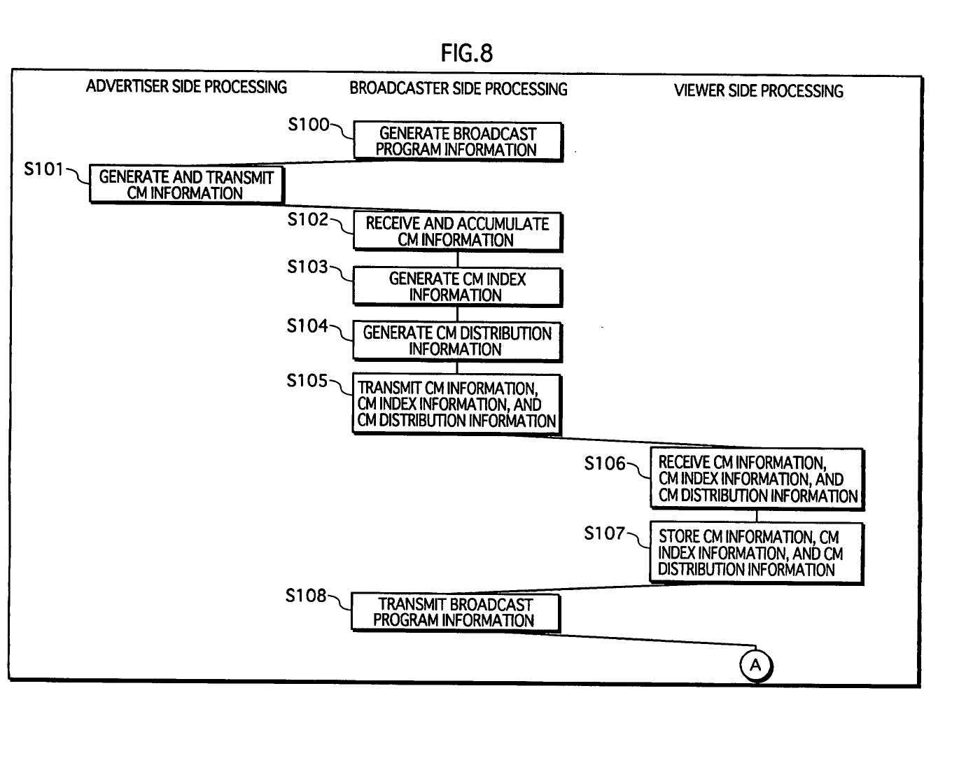

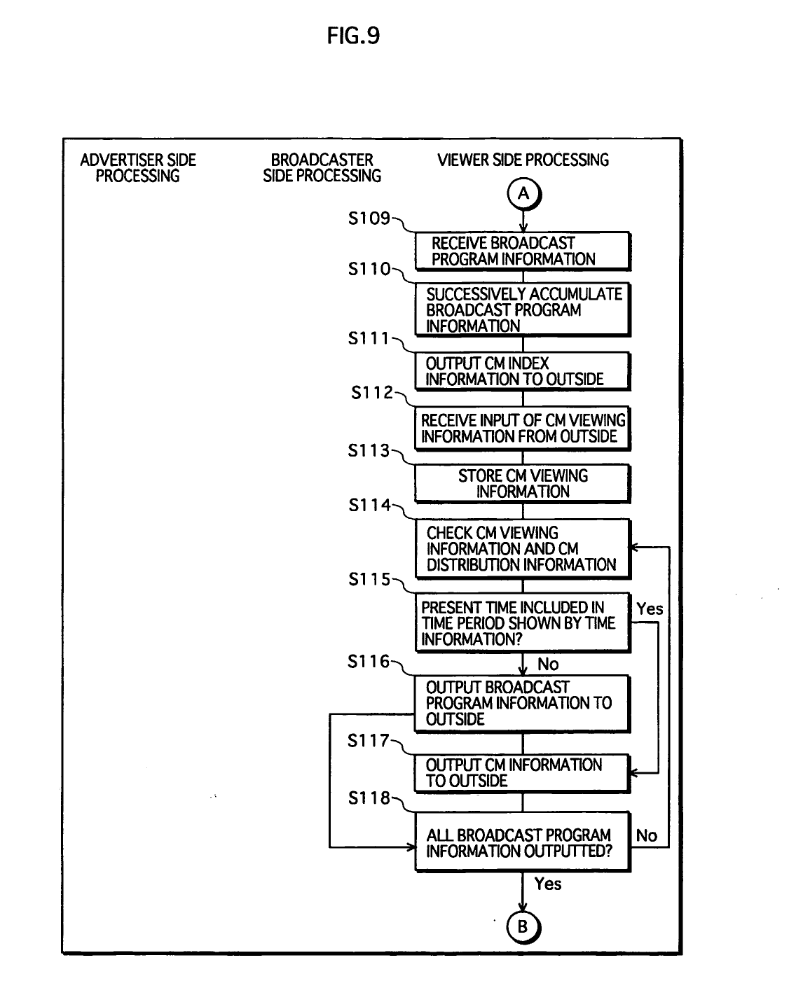

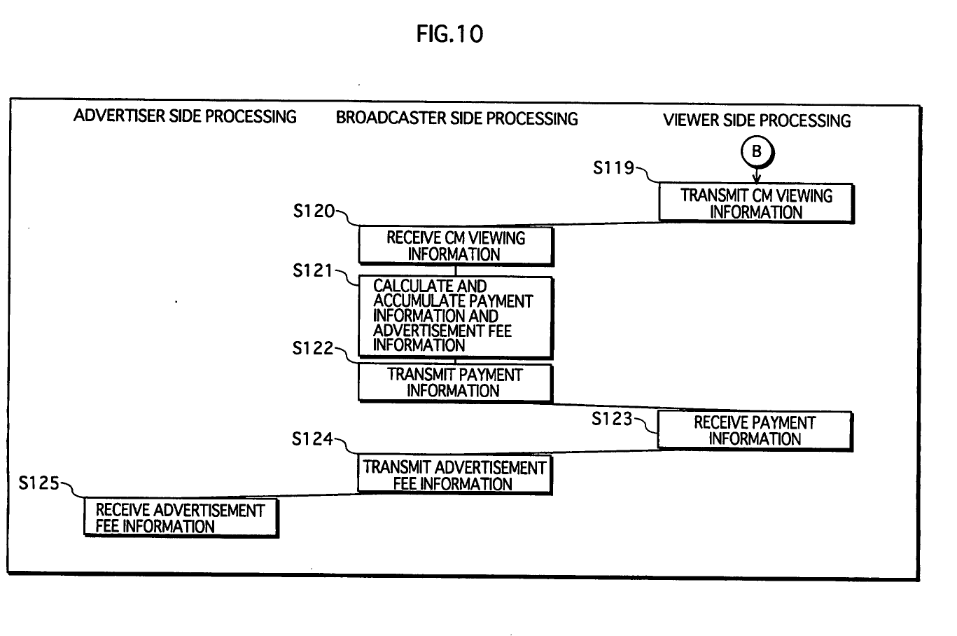

FIGS. 8, 9, and 10 respectively show the first part, the middle part, and the last part of a processing sequence of the broadcasting system 1. In the broadcasting system 1, (a) the broadcaster distributes a pay broadcast program using the broadcasting apparatus 11, charges the viewer with a viewing fee, and charges the advertiser with an advertisement fee; (b) the viewer views a pay broadcast program using the broadcast receiving apparatus 12, and pays a viewing fee to the broadcaster; and (c) the advertiser consigns broadcast of CM information to the broadcaster using the CM consigning apparatus 13, and pays an advertisement fee to the broadcaster.

The following describes the overall processing of the broadcasting system 1, with reference to FIGS. 8, 9, and 10.

Step S100: The broadcasting apparatus 11 generates and accumulates broadcast program information using the broadcast program information generating & accumulating unit 110.

Step S101: The CM consigning apparatus 13 generates and stores CM information using the CM information generating & storing unit 130, and outputs the CM information to the CM information transmission path 16 using the CM information transmitting unit 131.

Step S102: The broadcasting apparatus 11 receives the CM information via the CM information transmission path 16, adds a unique ID number to the CM information, and accumulates the CM information with the ID number, using the CM information receiving & accumulating unit 111.

Step S103: The broadcasting apparatus 11 generates and accumulates CM index information using the CM index information generating & accumulating unit 112.

Step S104: The broadcasting apparatus 11 generates and accumulates CM distribution information using the CM distribution information generating & accumulating unit 113.

Step S105: The broadcasting apparatus 11 outputs the CM information, the CM index information, and the CM distribution information to the broadcast transmission path 14, using the broadcast transmitting unit 114, at a time when the broadcast transmission path 14 is available, like in the nighttime.

Step S106: The broadcast receiving apparatus 12 receives the CM information, the CM index information, and the CM distribution information using the broadcast receiving unit 12, and inputs the received information into the control unit 121.

Step S107: The broadcast receiving apparatus 12 stores the CM information, the CM index information, and the CM distribution information into the storage unit 123, using the control unit 121.

Step S108: The broadcasting apparatus 11 outputs, to the broadcast transmission path 14, broadcast program information inputted using the broadcast transmitting unit 114 at the scheduled broadcast time of the broadcast program information.

Step S109: The broadcast receiving apparatus 12 receives broadcast program information using the broadcast receiving unit 120 at the scheduled broadcast time of the broadcast program information, and successively inputs the received broadcast program information into the control unit 121.

Step S110: The broadcast receiving apparatus 12 successively accumulates the broadcast program information inputted using the control unit 121, into the temporal accumulation unit 124.

Step S111: The broadcast receiving apparatus 12 reads CM index information using the control unit 121, and outputs the CM index information to the outside, using the output unit 122.

Step S112: The broadcast receiving apparatus 12 receives CM viewing information from the outside using the input unit 125, and inputs the CM viewing information into the control unit 121.

Step S113: The broadcast receiving apparatus 12 stores CM viewing information into the CM viewing information storage unit 126 using the control unit 121.

Step S114: The broadcast receiving apparatus 12 obtains an ID number shown by CM distribution information that matches an ID number shown by CM viewing information, using the control unit 121, and obtains time information for the CM information with this ID number, out of CM information included in the CM distribution information.

Step S115: When the present time is included in a time period shown by the time information obtained in step S114, the processing advances to step S117. In the other cases, the processing advances to step S116.

Step S116: The broadcast receiving apparatus 12 outputs, to the outside, using the output unit 122, broadcast program information that has been accumulated in the temporal accumulation unit 124 using the control unit 121. At the same time, the broadcast receiving apparatus 12 successively accumulates broadcast program information that is successively inputted into the temporal accumulation unit 124. The processing advances to step S118.

Step S117: The broadcast receiving apparatus 12 outputs, to the outside, using the output unit 122, CM information identified by an ID number that has been stored in the storage unit 123 using the control unit 121, during the time period shown by the CM distribution information. At the same time, the broadcast receiving apparatus 12 successively accumulates input broadcast program information into the temporal accumulation unit 124. The processing advances to step S118.

Step S118: When all broadcast program information is outputted to the outside using the output unit 122, the processing advances to step S119. In the other cases, the processing advances to step S114.

Step S119: The broadcast receiving apparatus 12 outputs CM viewing information that has been stored in the CM viewing information storage unit 126 using the control unit 121, to the information transmission path 15 using the CM viewing information transmitting unit 127.

Step S120: The broadcasting apparatus 11 receives CM viewing information via the information transmission path 15 using the CM viewing information receiving unit 115, and inputs the received CM viewing information to the payment information calculating & accumulating unit 116.

Step S121: The broadcasting apparatus 11 calculates payment information for the viewer using the payment information calculating & accumulating unit 116 and accumulates the payment information, and calculates advertisement fee information for the advertiser and accumulates the advertisement fee information.

Step S122: The broadcasting apparatus 11 outputs, at predetermined intervals, e.g., every month, payment information accumulated for the predetermined time period in the payment information calculating & accumulating unit 116, to the payment information transmission path 17 using the payment information transmitting unit 117.

Step S123: The broadcast receiving apparatus 12 receives the payment information via the payment information transmission path 17 using the payment information receiving & outputting unit 128, and outputs the received payment information to the outside.

Step S124: The broadcasting apparatus 11 outputs, at predetermined intervals, e.g., every month, advertisement fee information accumulated for the predetermined time period in the payment information calculating & accumulating unit 116, to the advertisement fee information transmission path 18 using the advertisement fee information transmitting unit 118.

Step S125: The CM consigning apparatus 13 receives the advertisement fee information via the advertisement fee information transmission path 18 using the advertisement fee information receiving & outputting unit 121, and outputs the received advertisement fee information to the outside.

The description given so far is on the overall processing of the broadcasting system 1. After this processing, the viewer pays a pay broadcast program viewing fee shown by the payment information to the broadcaster, and the advertiser pays an advertisement fee shown by the advertisement fee information to the broadcaster. A method for these payments is not particularly described in this specification.

According to the broadcasting system 1 described above based on the above embodiment, in the case where the broadcaster successively distributes pay broadcast programs each at its scheduled broadcast time and the viewer successively views the pay broadcast programs each at its scheduled broadcast time, the broadcasting apparatus 11 transmits, in advance, CM index information to the broadcast receiving apparatus 12 in step S105, and the broadcast receiving apparatus 12 outputs, in advance, the CM index information to the viewer in step S111. Due to this, the viewer is allowed to select CMs that he or she wants in step S112. Further, as a result of this selection, the viewer is allowed to select a viewing fee to be charged for broadcast program information in step S123.

(Modifications)

The embodiment described above is merely one example of the present invention. It should be clear that the present invention is not limited to such. Various modifications are possible within a range that does not exceed the technical concept of the present invention.

(1) CM index information should not be limited to the information described in the above embodiment, but may be any information that can serve as an indicator with which the viewer can select CMs that he or she wants.

For example, a production date, a viewing record, a representative image, a performer's name etc. of CM information may be added to the CM index information. A production date provides the viewer with an indicator for judging whether a CM is the latest one or not. A viewing record provides the viewer with an indicator for judging whether the viewer has viewed a CM frequently or not. A representative image provides the viewer with a clue to know the contents of a CM and is helpful in selecting CMs. A performer's name is helpful in judging whether a CM is in viewer's favor or not.

In a case where the viewing record is added to the CM index information, the number of times each CM has been viewed can be checked, so that a viewer's favorite company whose CMs have been frequently viewed or a viewer's favorite performer whose CMs have been frequently viewed can be checked. In this case, CM information of the viewer's favorite company or CM information of the viewer's favorite performer may be extracted, and CM index information may be generated to include such CM information of the viewer's favorite company or CM information of the viewer's favorite performer.

Also, CM information may be provided with a priority level according to a recommendation rating by the broadcaster. In this case, CM index information can list CM information in the order of a higher priority level.

Also, the CM index information may list a recommended CM information group 1, a recommended CM information group 2, etc., each of which is composed of a plurality of recommended CMs, so that the viewer can select one of the recommended CM information groups. In this case, the CM index information may also display a total discount amount for each recommended CM information group, so that the viewer can select CMs with a higher discount rate.

(2) Broadcast program information, CM information, CM distribution information, and CM viewing information are not limited to those described in the above embodiment, but may be any information as long as they are respectively transmission information for pay broadcast programs, transmission information for CM broadcasts, information indicating where each CM broadcast is to be inserted into a broadcast program, and information about CM broadcasts that the viewer wants.

(3) Each of broadcast program information, CM information, CM distribution information, and CM index information may be obtained with being recorded on a recording medium. That is to say, the broadcast program information, CM information, and CM distribution information may be recorded on a recording medium, and this recording medium maybe physically sent to the viewer via such methods as mailing, selling, and distributing. This can realize such a broadcasting system in which the broadcaster can provide, at a low cost, the viewer with a recording medium on which broadcast program information is recorded, and if the viewer wants CM information, the viewer can view the broadcast program information without being required to pay any additional fee, and if the viewer does not want to view the CM information, the viewer is required to pay an additional fee for viewing the broadcast program information, according to the degree of not viewing CM information.

Also, the CM viewing information may be obtained by the broadcaster as being recorded on a recording medium. To be specific, the CM viewing information may be recorded on a recording medium, and this recording medium can be physically sent to the broadcaster by such methods as mailing, selling, and distributing. Due to this, the viewer can provide, at a low cost, the broadcaster with a recording medium on which CM viewing information is recorded.

(4) Each of broadcast program information, CM information, CM distribution information, and CM index information may be transmitted via a different transmission path. For example, when the broadcast program information and the CM information are transmitted at the same time via different transmission paths, the control unit 121 reads the CM information that is transmitted at the same time with the broadcast program information via a different transmission path, instead of reading the CM information from the storage unit 123. In this case, the CM information does not need to be stored in advance in the storage unit 123. Also, for example, when the broadcast program information and the CM distribution information are transmitted at the same time via different transmission paths, the control unit 121 reads the CM distribution information that is transmitted at the same time with the broadcast program information via a different transmission path, instead of reading the CM distribution information from the storage unit 123. In this case, the CM distribution information does not need to be stored in advance in the storage unit 123. Also, for example, in a case where CM information is stored in the storage unit 123, the CM information may be updated regularly using the transmission path at a time when the transmission path is available, like in the nighttime, or using a different transmission path.

(5) Although the viewer selects CM information that the viewer wants by referring to CM index information before viewing broadcast program information, the viewer can also change CM information that the viewer wants while viewing the broadcast program information. For example, the input unit 125 may be provided with a button for selecting all CM broadcasts to be viewed. By the viewer pressing this button, CM viewing information listing all the remaining CM broadcasts is inputted into the control unit 121. Then, the control unit 121 may write this new CM viewing information over the old CM viewing information in the CM viewing information storage unit 126. This results in the remaining CM broadcasts all being provided to the viewer. In this way, the viewer can change the selection of CMs that the viewer wants, while he or she is viewing the broadcast program.

(6) The number of broadcasters, viewers, and advertisers is not particularly limited, but may either be singular or plural.

(7) CM index information may not be generated at the broadcaster side but may be generated at the reception apparatus side in the following way. CM information is accumulated in advance in the storage unit of the reception apparatus. The accumulated CM information is read, CM information to be inserted into broadcast program information is selected, CM index information listing the selected CM information in association with an ID number, a product type (e.g., an advertising company name, or an advertising commodity such as food, music, and car), a broadcast time, and a discount amount by which a program viewing fee is discounted when the CM information is viewed, is generated, and the generated CM index information is accumulated.

In such a construction where CM index information is generated at the reception apparatus side, it is preferable that the generated CM index information is transmitted to the broadcaster, and the broadcaster generates distribution information for CM information listed in the transmitted CM index information. This is because broadcast time periods of broadcast programs are supposed to be managed by the broadcaster. Alternatively, the broadcaster may generate distribution information for CM information, and transmit the generated distribution information to the reception apparatus. Then, the reception apparatus may generate CM distribution information, based on the transmitted distribution information, i.e., by replacing an ID number of CM information included in the transmitted distribution information with an ID number of CM information included in the CM index information and leaving broadcast time information included in the transmitted distribution information as it is.

Methods for generating CM distribution information may not be particularly limited to these, but may be other methods.

(8) CM information may be produced by a third party such as an advertisement agency, and may be transmitted to the broadcasting apparatus 21. Further, instead of CM viewing information for every broadcast program, CM viewing information for every predetermined time period may be transmitted to the broadcasting apparatus 21.

(9) Payment information and advertisement fee information may be not be limited to those described in the above embodiment, but may respectively be any information about a viewing fee of broadcast program information and any information about an advertisement fee. Further, instead of payment information and advertisement fee information for every predetermined time period, payment information and advertisement fee information for every broadcast program may be transmitted. Further, payment information and advertisement fee information may be obtained as being recorded on recording media.

(10) The present invention is also applicable when one or more of broadcast program information, CM information, CM index information, and CM distribution information are recorded in advance on recording media such as a semiconductor memory, a hard disk drive, and a DVD-RAM. For example, when all of broadcast program information, CM information, CM index information, and CM distribution information are recorded on recording media, the present invention can include such a case where a broadcast program is recorded using a recording device and the recorded broadcast program is viewed.

To be more specific, the viewer views index information of CM broadcasts recorded on a recording medium, and selects CM broadcasts that the viewer wants to view, and views a pay broadcast program in which only the selected CM broadcasts are inserted based on CM distribution information, out of pay broadcast programs and CM broadcasts recorded on the recording medium, and transmits a selection result of the CM broadcasts that the viewer actually has viewed, to the broadcaster using the information transmission path 15.

Then, by referring to the selection result transmitted using the information transmission path 15, the broadcaster calculates a fee of the pay broadcast program to be charged to the viewer, by subtracting a discount amount according to the degree of CM broadcasts viewed by the viewer, from a predetermined viewing fee of the pay broadcast program, and transmits information about the discounted viewing fee to the viewer, using the payment information transmission path 17. Here, a viewing fee of the pay broadcast program to be paid to the broadcaster decreases as the degree of CM broadcasts viewed by the viewer increases. To make up for the decreased amount, the broadcaster increases an advertisement fee of the CM broadcasts to be paid by the advertiser, according to the degree of CM broadcasts viewed by the viewer. The broadcaster transmits information about the increased advertisement fee to the advertiser so as to obtain the decreased amount of the viewing fee, using the advertisement fee information transmission path 18.

As described above, the viewer can select CM broadcasts that he or she wants, and as a result of this selection, the viewer can select a utilization fee of a pay broadcast program.

(11) The present invention is applicable not only to presentation of broadcast program information but also to presentation of content that is software such as broadcast programs, movies, documents, musical compositions, and databases, and combinations of these.

(12) It should be clear that the contents of the above embodiment and the modification examples may be executed independently, or any combinations of these contents may be executed.

As described above, the present invention in view of the problems of conventional systems enables such a broadcasting system in which index information of CMs to be inserted into pay content is provided to a content user, so that the content user can select CMs that the user wants, and as a result of this selection, a utility fee of the pay content is determined accordingly.

The present invention, therefore, can realize a broadcasting system that is impossible with conventional techniques, and as such, the present invention is considered highly valuable.

### INDUSTRIAL APPLICATION

The present invention can be utilized in a content broadcasting system.

1. A content presenting apparatus, comprising:
a content obtaining unit for obtaining a main-content and a sub-content;
a time-information obtaining unit for obtaining presentation time information for a sub-content, the presentation time information indicating a start point and an end point of presenting the sub-content to a user;
an index-information presenting unit for presenting, to the user, sub-content index information describing a characteristic of each of a plurality of sub-contents, the characteristic including at least one of (a) a discount amount by which a viewing fee is discounted when the user views the sub-content, (b) a product type relating to the sub-content, and (c) a presentation time length of the sub-content;
a user-selection receiving unit for receiving, from the user, a selection of a sub-content out of the plurality of sub-contents described in the sub-content index information;
a specification-information generating unit for generating specification information that specifies the sub-content selected by the user;
a main-content presenting unit for presenting the main-content to the user; and
a sub-content presenting unit for presenting, to the user, the sub-content specified by the specification information, from a start point to an end point indicated by presentation time information for the specified sub-content, within a time period from when presentation of the main-content is started to when presentation of the main-content is ended.

2. The content presenting apparatus of claim 1, further comprising,
an index-information obtaining unit for obtaining, from an index-information generating apparatus, the sub-content index information that is presented by the index-information presenting unit.

3. The content presenting apparatus of claim 1, further comprising,
an index-information generating unit for generating the sub-content index information that is presented by the index-information presenting unit, the index-information generating unit including:
an accumulation unit that accumulates sub-contents, in association with IDs identifying the sub-contents and description information describing the sub-contents; and
an extraction unit that extracts, from the accumulation unit, sub-contents to be described in the sub-content index information, by referring to the description information describing the sub-contents.

4. The content presenting apparatus of claim 1,
wherein each sub-content is an advertisement,
the characteristic of each sub-content described by the sub-content index information includes (a) a discount amount by which a viewing fee is discounted when the user views the sub-content, (b) a company name relating to a product to be advertised by the sub-content, and (c) a presentation time length of the sub-content.

5. The content presenting apparatus of claim 4,
wherein the characteristic of each sub-content described by the sub-content index information includes an image of the sub-content.

6. An index-information generating apparatus, comprising:
a content outputting unit for outputting a main-content and a sub-content to a recording medium or a content presenting apparatus;
an index-information generating unit for generating sub-content index information describing a characteristic of each of a plurality of sub-contents, the characteristic including at least one of (a) a discount amount by which a viewing fee is discounted when the user views the sub-content, (b) a product type relating to the sub-content, and (c) a presentation time length of the sub-content;
an index-information outputting unit for outputting the sub-content index information to the recording medium or the content presenting apparatus; and
a time-information outputting unit for outputting presentation time information for each sub-content to the recording medium or the content presenting apparatus, the presentation time information indicating a start point and an end point of presenting the sub-content to the user.

7. The index-information generating apparatus of claim 6,
wherein the index-information generating unit includes:
an accumulation unit that accumulates sub-contents, in association with IDs identifying the sub-contents and description information describing the sub-contents; and
an extraction unit that extracts, from the accumulation unit, sub-contents to be described in the sub-content index information, by referring to the description information describing the sub-contents.

8. A content presenting system comprising a transmission apparatus for transmitting content and a reception apparatus for receiving content,
the transmission apparatus including:
a content transmitting unit for transmitting a main-content and a sub-content;
a time-information transmitting unit for transmitting presentation time information for a sub-content, the presentation time information indicating a start point and an end point of presenting the sub-content to a user; and
an index-information transmitting unit for transmitting sub-content index information describing a characteristic of each of a plurality of sub-contents, the characteristic including at least one of (a) a discount amount by which a viewing fee is discounted when the user views the sub-content, (b) a product type relating to the sub-content, and (c) a presentation time length of the sub-content,
the reception apparatus including:
a content receiving unit for receiving the main-content and the sub-content;
a time-information receiving unit for receiving the presentation time information;
an index-information receiving unit for receiving the sub-content index information;
an index-information presenting unit for presenting, to the user, the sub-content index information received by the index-information receiving unit;
a user-selection receiving unit for receiving, from the user, a selection of a sub-content out of the plurality of sub-contents described in the sub-content index information;
a specification-information generating unit for generating specification information that specifies the sub-content selected by the user;
a main-content presenting unit for presenting the main-content to the user; and
a sub-content presenting unit for presenting, to the user, the sub-content specified by the specification information, from a start point to an end point indicated by presentation time information for the specified sub-content, within a time period from when presentation of the main-content is started to when presentation of the main-content is ended.

9. The content presenting system of claim 8,
wherein the reception apparatus further includes,
a specification-information outputting unit for outputting the specification information to a recording medium or the transmission apparatus, after the sub-content presenting unit has completed presentation of each sub-content specified by the specification information to the user, and
the transmission apparatus further includes:
a specification-information obtaining unit for obtaining the specification information; and
a first payment-amount determining unit for determining a payment amount to be charged to the reception apparatus, based on the specification information.

10. The content presenting system of claim 9,
wherein the transmission apparatus further includes,
a first payment-amount outputting unit for outputting the payment amount determined by the first payment-amount determining unit, to a recording medium or the reception apparatus, and
the reception apparatus further includes:
a payment-amount obtaining unit for obtaining the payment amount; and
a payment-amount presenting unit for presenting the payment amount to the user.

11. The content presenting system of claim 10,
wherein the transmission apparatus further includes:
a second payment-amount determining unit for determining a payment amount to be charged to a sub-content production apparatus, based on the obtained specification information; and
a second payment-amount outputting unit for outputting the payment amount determined by the second payment-amount determining unit, to a recording medium or the sub-content production apparatus.

12. The content presenting system of claim 9,
wherein each sub-content is an advertisement,
the transmission apparatus includes:
an accumulation unit for receiving and accumulating a plurality of sub-contents; and
an index-information generating unit for setting a different ID for each of the accumulated sub-contents, and generating the sub-content index information so as to include (a) an ID of each sub-content, (b) a discount amount by which a viewing fee is discounted when the user views each sub-content, (c) a company name relating to a product to be advertised by each sub-content, and (d) a presentation time length of each sub-content,
the content transmitting unit transmits each sub-content received by the accumulation unit,
the index-information transmitting unit transmits the sub-content index information generated by the index-information generating unit, and
the specification information generating unit generates the specification information so as to include an ID of the selected sub-content.
